(19) United States
(12) Patent Application Publication
(10) Pub. No.: US 2022/0185321 A1
(43) Pub. Date: Jun. 16, 2022

(54) AN ON-BOARD CONTROL SYSTEM FOR OPERATING A VEHICLE

(71) Applicant: VOLVO TRUCK CORPORATION, Göteborg (SE)

(72) Inventors: Teodoro BORA, Göteborg (SE); Johan FRIES, Gråbo (SE); Laurent BOISSON, Condrieu (FR)

(73) Assignee: VOLVO TRUCK CORPORATION, Göteborg (SE)

(21) Appl. No.: 17/593,724

(22) PCT Filed: Apr. 2, 2019
(86) PCT No.: PCT/EP2019/058310

§ 371 Date: Sep. 23, 2021

(51) Int. Cl. B60W 60/00; B60W 40/105; G07C 5/00

(52) U.S. Cl. CPC B60W 60/001; B60W 2510/10; G07C 5/008; B60W 40/105

(57) ABSTRACT

The present disclosure relates to an on-board control system (200) for operating a vehicle (100, 102, 104), the control system (200) comprising processing circuitry (202) and a plurality of sensors (204, 206, 208) arranged with the vehicle (100). The control system (200) employs e.g. a general vehicle control model (M) for operating the vehicle (100, 102, 104), where the vehicle control model (M) is specifically adapted for the vehicle (100, 102, 104) based on an ongoing operation of the vehicle (100, 102, 104). The present disclosure also relates to a corresponding computer implemented method and to a computer program product.

### TECHNICAL FIELD

The present disclosure relates to an on-board control system for operating a vehicle, the control system comprising processing circuitry and a plurality of sensors arranged with the vehicle. The control system employs e.g. a general vehicle control model for operating the vehicle, where the vehicle control model is specifically adapted for the vehicle based on an ongoing operation of the vehicle. The present disclosure also relates to a corresponding computer implemented method and to a computer program product.

### BACKGROUND

Recently there have been great advances in the semi or fully autonomous operation of a vehicle, effectively providing driver assistance and safety functions, such as cruise control, etc. Conventional cruise control systems fulfil the function of speed control of the vehicle, where a desired speed is selected by the driver and an on-board control system operates on the engine of the vehicle to maintain the desired speed.

When the traffic is light, this simple speed control may be acceptable to the driver, however as soon as slightly more complicated traffic situations occur the operation of the vehicle will be experienced as “jerky” for anyone travelling with the vehicle. Accordingly, a more advanced scheme is desirable for controlling the operation of the vehicle.

An example of such a scheme is presented in U.S. Pat. No. 9,849,880, where a model of the vehicle is used. The vehicle control model in turn provides an output to a nonlinear model predictive cruise control routine, whereby it may be possible to provide the technical result of reducing vehicle torque demand swings while operating a vehicle in a cruise control mode. This is in U.S. Pat. No. 9,849,880 achieved by taking into account a priori road grade information. Furthermore, in U.S. Pat. No. 9,849,880 the vehicle control model may be updated in real-time while the vehicle is in cruise control mode, allowing for an adjustment of a torque control strategy from a constant torque output to a pulse and glide torque output, thereby allowing multiple torque solution strategies from the controller for same driving conditions.

Even though the solution in U.S. Pat. No. 9,849,880 presents an interesting approach to control of the vehicle operation, it is overly complicated and relies on said a priori road grade information. Accordingly, there appears to be room for further improvements in regards to the scheme to be used for operational control of the vehicle, specifically targeted towards computational efficiency suitable for an in-vehicle implementation, possibly also allowing for improved robustness of the vehicle operation.

### SUMMARY

According to an aspect of the present disclosure, the above is at least partly alleviated by an on-board control system for operating a vehicle, the control system comprising processing circuitry and a plurality of sensors arranged with the vehicle, the processing circuitry arranged in communication with the plurality of sensors, wherein the processing circuitry is adapted to receive a reference control value for operating the vehicle, receive vehicle state values from the plurality of sensors, provide the reference control value and the vehicle state values as inputs to a vehicle control model, wherein the vehicle control model is adapted to form a compensation control value for operating the vehicle, operate the vehicle based on a combination of the reference control value and the compensation control value, receive vehicle data resulting from the operation of the vehicle, determine a difference between the reference control value and the vehicle data, and update the vehicle control model if the determined difference is above a predetermined threshold.

The present disclosure is based upon the realization that the operational control of the vehicle may be improved by introducing an updatable vehicle control model. Since the vehicle control model may be e.g. iteratively updated based on how well the vehicle control model “behaves”, the initially used vehicle control model may be fairly generalized and not necessarily explicitly adapted for the specific vehicle. This makes the inventive control strategy specifically useful in situations where different vehicles of the same type/make/model have inherent differences, such as based on differences in the manufacturing of the different vehicles.

Furthermore, using an iteratively updatable vehicle mode, where the vehicle control model should be interpreted as an expected behavior of at least some portions of the vehicle, allows for an in comparison smoother operation of the vehicle since a transient phase can be drastically reduced and the overall control strategy improved. Such a feature is particularly important for applications demanding high precise speed/acceleration control, such as for example in relation to an autonomous vehicle.

Further advantages following the use of the presented control scheme, by means of the updating vehicle control model, is that it permits the system to adapt for unpredictable situations as ageing of components, changes in the vehicle characteristics, environmental conditions, etc.

It is worth noticing that the expression “autonomous vehicle”, as used above, should be interpreted broadly and relates to a vehicle that is operated in a fully or partially autonomous mode. In a partially autonomous vehicle some functions can optionally be manually controlled (e.g. by a driver) some or all of the time. Further, a partially autonomous vehicle may be configured to switch between a fully-manual operation mode and a partially-autonomous and/or a fully-autonomous operation mode.

The processing circuitry may in one embodiment be an electronic control unit (ECU) that typically is provided as an onboard component of the vehicle. Correspondingly, the sensors may for example include sensors for determining an intermediate operation of the vehicle, such as including speed, acceleration, inclination, torque, vehicle mass, etc. Consequently, in a preferred embodiment the vehicle state values are selected from a group comprising one or a plurality of a road inclination, a vehicle mass, a speed of the vehicle, power limits for the vehicle, gear box ratio, etc. Other sensors, real and virtual, may be used/included and are considered within the scope of the present disclosure. A virtual sensor may be seen as providing a value that not necessary is measured, but rather determined and/or acquired through a user interface or from information recorded at the vehicle.

In a preferred embodiment of the present disclosure, the processing circuitry implements a control function, and the control function receives the difference between the reference control value and the vehicle data. The control function may in turn be implemented as a PID controller. Accordingly, the control function will in such an embodiment function together with the vehicle control model for controlling the operation of the vehicle. In comparison to a prior-art solution only using e.g. a PID controller, the implementation according to the present disclosure will allow for the e.g. PID controller to be greatly simplified, since the PID controller must not be adapted for all different situations. That is, the vehicle control model may in such embodiments be seen as being used for compensation rather than direct control of the vehicle. A further advantage following the present disclosure is that the inclusion of the updatable vehicle control model simplifies the design of the control function, such as in regards to a closed-loop controller.

In an embodiment of the present disclosure, an output from the control function is combined with the compensation control value for forming a control signal, and the control signal is applied to operate the vehicle. Accordingly and in line with the above discussion, the compensation control value provided by the vehicle control model is combined with the output from the control function for operating the vehicle.

As an example, the reference control value may in one embodiment be selected to be a desired acceleration value and or a desired speed value for the vehicle. Such reference control value may thus be selected for operating the vehicle in e.g. a cruise control mode. However, other reference control values may be possible and within the scope of the present disclosure, such as controlling the vehicle in regards to a desired torque value, etc. Accordingly, the scheme as presented in line with the present disclosure is adaptable for operating different vehicle functionality.

Preferably, the vehicle data is a measured output resulting from the operation of the vehicle. In some embodiments, the same or similar sensors may be used for determining the current operational state of the vehicle. Other sensors may of course also be included.

Furthermore, in an embodiment of the present disclosure the predetermined threshold is dependent on the reference control value. As an example, the threshold must not necessarily be fixed, but may be dependent on what is desired to be controlled (e.g. desired acceleration value and or a desired speed value for the vehicle), where different reference control value (entities) may be selected to have different thresholds.

In a preferred embodiment of the present disclosure, the updated vehicle control model is transmitted to a remote server arranged off-board the vehicle arranged in networked communication with the processing circuitry. Accordingly, in case the vehicle control model is updated, this updated vehicle control model may possibly be shared with e.g. other similar vehicle types. As a result, the vehicle receiving the updated vehicle control model may in turn “work” on the vehicle control model to make it specific for that vehicle.

Furthermore, vehicle control models may in some embodiments be mission specific or specific for a road portion, country, altitude, etc. As an example, a vehicle starting a specific mission may in some embodiment be provided (e.g. received from the remote server) with such a mission specific vehicle control model to be used as the “initial” vehicle control model as defined above. Once the mission is completed, the then updated vehicle control model may be used by other vehicles intended to in the future operate in line with the mission.

In a preferred embodiment of the present disclosure, the on-board control system is provided as a component of the vehicle, typically further comprising the above-mentioned sensors. The vehicle may in turn be e.g. one of a bus, a truck, a car, or any form of construction equipment. The vehicle may furthermore be at least one of a pure electrical vehicle (PEV) and a hybrid electric vehicle (HEV)

According to another aspect of the present disclosure there is provided a computer implemented method for operating a control system arranged on-board a vehicle, the control system comprising processing circuitry and a plurality of sensors arranged with the vehicle, the processing circuitry arranged in communication with the plurality of sensors, wherein the method comprises the steps of receiving (S1), at the processing circuitry, a reference control value for operating the vehicle, receiving (S2), at the processing circuitry, vehicle state values from the plurality of sensors, providing (S3), by the processing circuitry, the reference control value and the vehicle state values as inputs to a vehicle control model, wherein the vehicle control model is adapted to form a compensation control value for operating the vehicle, operating (S4), by the processing circuitry, the vehicle based on a combination of the reference control value and the compensation control value, receiving (S5), at the processing circuitry, vehicle data resulting from the operation of the vehicle, determining (S6), at the processing circuitry, a difference between the reference control value and the vehicle data, and updating (S7), at the processing circuitry, the vehicle control model if the determined difference is above a predetermined threshold. This aspect of the present disclosure provides similar advantages as discussed above in relation to the previous aspect of the present disclosure.

According to a further aspect of the present disclosure there is provided a computer program product comprising a non-transitory computer readable medium having stored thereon computer program means for operating a control system arranged on-board a vehicle, the control system comprising processing circuitry and a plurality of sensors arranged with the vehicle, the processing circuitry arranged in communication with the plurality of sensors, wherein the computer program product comprises code for receiving, at the processing circuitry, a reference control value for operating the vehicle, code for receiving, at the processing circuitry, vehicle state values from the plurality of sensors, code for providing, by the processing circuitry, the reference control value and the vehicle state values as inputs to a vehicle control model, wherein the vehicle control model is adapted to form a compensation control value for operating the vehicle, code for operating, by the processing circuitry, the vehicle based on a combination of the reference control value and the compensation control value, code for receiving, at the processing circuitry, vehicle data resulting from the operation of the vehicle, code for determining, at the processing circuitry, a difference between the reference control value and the vehicle data, and code for updating, at the processing circuitry, the vehicle control model if the determined difference is above a predetermined threshold. Also this aspect of the present disclosure provides similar advantages as discussed above in relation to the previous aspects of the present disclosure.

The computer readable medium may be any type of memory device, including one of a removable nonvolatile random access memory, a hard disk drive, a floppy disk, a CD-ROM, a DVD-ROM, a USB memory, an SD memory card, or a similar computer readable medium known in the art.

Further advantages and advantageous features of the present disclosure are disclosed in the following description and in the dependent claims.

### BRIEF DESCRIPTION OF THE DRAWINGS

With reference to the appended drawings, below follows a more detailed description of embodiments of the present disclosure cited as examples.

In the drawings:

FIG. 1A illustrates a truck, 1B a bus and 1C a wheel loader in which the control system according to the present disclosure may be incorporated;

FIG. 2 illustrates a conceptual control system in accordance to a currently preferred embodiment of the present disclosure; and

FIG. 3 illustrates the processing steps for performing the method according to the present disclosure.

### DETAILED DESCRIPTION OF EXAMPLE EMBODIMENTS OF THE INVENTION

The present disclosure will now be described more fully hereinafter with reference to the accompanying drawings, in which currently preferred embodiments of the present disclosure are shown. This disclosure may, however, be embodied in many different forms and should not be construed as limited to the embodiments set forth herein; rather, these embodiments are provided for thoroughness and completeness, and fully convey the scope of the disclosure to the skilled addressee. Like reference characters refer to like elements throughout.

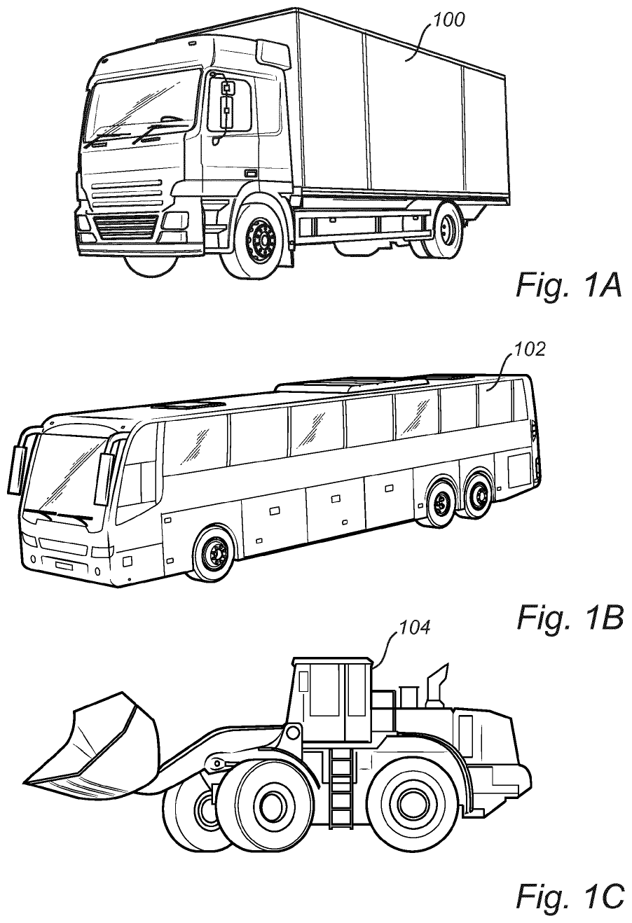

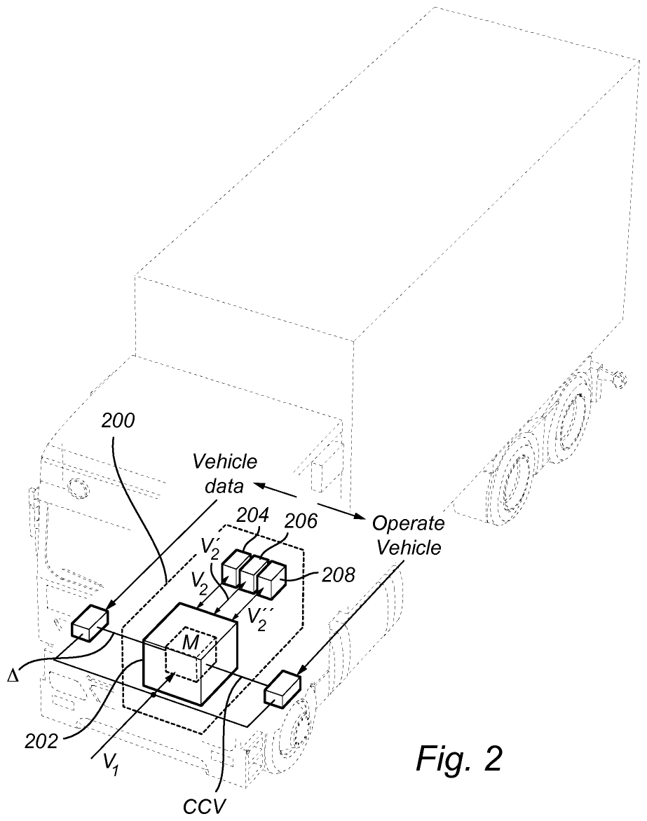

Referring now to the drawings and to FIG. 1A in particular, there is depicted an exemplary vehicle, here illustrated as a truck 100, in which a control system 200 (as shown in FIG. 2) according to the present disclosure may be incorporated. The control system 200 may of course be implemented, possibly in a slightly different way, in a bus 102 as shown in FIG. 1B, wheel loader as shown in FIG. 1C, a car, a bus, etc.

The vehicle may for example be one of an electric or hybrid vehicle, or possibly a gas, gasoline or diesel vehicle. The vehicle comprises an electric machine (in case of being an electric or hybrid vehicle) or an engine (such as an internal combustion engine in case of being a gas, gasoline or diesel vehicle). The vehicle may further be manually operated, fully or semi-autonomous.

FIG. 2 shows a conceptual and exemplary implementation of the control system 200, comprising a processing circuitry 202, such as an electronic control unit (ECU), adapted for operating e.g. any one of the vehicles 100, 102, 104. The ECU 202 implements an interface for receiving data from a plurality of sensors 204, 206, 208, such as e.g. for measuring one of a speed, an acceleration, an inclination, a torque, etc. of the vehicle 100, 102, 104. The control system 200 may further comprise a database (not shown) for storing a vehicle control model to be used by the ECU 202 in operating the vehicle. The control system 200 may also be provided with an interface for allowing the vehicle control model to be received at and transmitted from the ECU 202, such as from and to a remotely located server (not shown).

For reference, the ECU 202 may for example be manifested as a general-purpose processor, an application specific processor, a circuit containing processing components, a group of distributed processing components, a group of distributed computers configured for processing, a field programmable gate array (FPGA), etc. The processor may be or include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

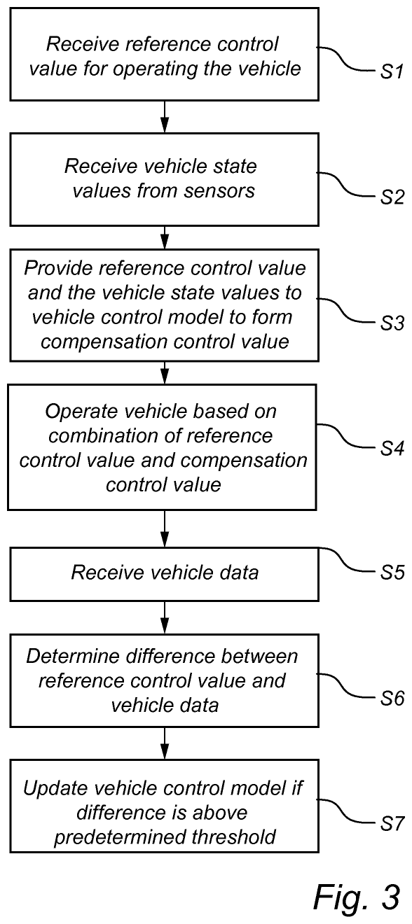

During operation of the control system 200 for controlling the operation of the vehicle 100, 102, 104, with further reference to FIG. 3, the ECU 202 is “loaded” with the vehicle control model, M. As mentioned, the vehicle control model, M, may be seen as a generalized expectation of how a function of the vehicle 100, 102, 104. The vehicle control model, M, may, as also mentioned, be received from e.g. a remote server, or at the time of manufacture of the vehicle 100, 102, 104.

Initially, e.g. the driver or an autonomy process of the vehicle 100, 102, 104 sets a reference control value V1 for operating the vehicle 100, 102, 104, such as e.g. one of a speed or an acceleration for the vehicle 100, 102, 104. The reference control value V1 is received, S1, at the ECU 202. The ECU 202 also receives, S2, vehicle state values V2, V2′, V2″ from the plurality of sensors 204, 206, 208, such as from sensors adapted for measuring one of a speed, an acceleration, an inclination, a torque, etc. of the vehicle 100, 102, 104. Other data may be provided, such as e.g. a weight of the vehicle 100, 102, 104, etc.

In line with the present disclosure, the reference control value V1 and the vehicle state values V2, V2′, V2″ are then provided, S3, as inputs to the vehicle control model, M, which may be seen as e.g. a mathematical representation or set of processing steps of the function of the vehicle. The vehicle control model, M, is in turn adapted to form a compensation control value, CCV. The vehicle 100, 102, 104 is then operated, S4, based on a combination of the reference control value V1 and the compensation control value, CCV.

As indicated above, the ECU 202 preferably implements a control function. The control function, for example implemented as a PID controller, typically receives the reference control value V1 as well as data relating to the present operation of the vehicle 100, 102, 104. The control function then operates to reduce the difference between e.g. the desired speed (i.e. the reference control value V1) and a current speed of the vehicle 100, 102, 104. However, in line with the present disclosure the vehicle control model, M, is used for introduce a dynamic compensation factor, i.e. the compensation control value, CCV, between the output from the control function and the function of the vehicle 100, 102, 104 that is to be controlled.

Furthermore, following the operation of the vehicle 100, 102, 104, the ECU 202 receives, S5, vehicle data VD resulting from the operation of the vehicle 100, 102, 104. The vehicle data VD may typically be seen as how the vehicle currently is behaving as compared to the reference control value V1. Accordingly, a difference A is determined, S6, between the vehicle data VD and the reference control value V1. If the difference then is determined to above a predetermined threshold (e.g. the difference is larger than what is desirable), this means that the vehicle control model M is to be updated, S7.

The scheme according to the present disclosure may thus be seen as a constant recording of different operation points x while the control system 200 runs. This set of samples is then used to recursively regress to a function that describes the operation of the functionality of the vehicle that is described using the vehicle control model, M. It is thus desirable to adapt the vehicle control model M such that an uncertainty of the model is equal to a real uncertainty for the actual operation of the vehicle 100, 102, 104.

Accordingly, in case the control system 200 is operated “long enough” (time co), then the output from the control function (such as implemented as the exemplified PID controller) tends to go towards zero. This will thus mean that the vehicle control model M provides a correct compensation control value CCV for the present operational condition for the vehicle 100, 102, 104.

The present disclosure contemplates methods, devices and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor.

By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general-purpose computer, special purpose computer, or special purpose processing machines to perform a certain function or group of functions.

Although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

Additionally, even though the disclosure has been described with reference to specific exemplifying embodiments thereof, many different alterations, modifications and the like will become apparent for those skilled in the art.

Variations to the disclosed embodiments can be understood and effected by the skilled addressee in practicing the claimed disclosure, from a study of the drawings, the disclosure, and the appended claims. Furthermore, in the claims, the word “comprising” does not exclude other elements or steps, and the indefinite article “a” or “an” does not exclude a plurality.

1. An on-board control system (200) for operating a vehicle (100, 102, 104), the control system (200) comprising processing circuitry (202) and a plurality of sensors (204, 206, 208) arranged with the vehicle (100), the processing circuitry (200) arranged in communication with the plurality of sensors (204, 206, 208), wherein the processing circuitry (202) is adapted to:
receive a reference control value (V1) for operating the vehicle (100),
receive vehicle state values (V2, V2′, V2″) from the plurality of sensors (204, 206, 208),
provide the reference control value (V1) and the vehicle state values (V2, V2′, V2″) as inputs to a vehicle control model (M), wherein the vehicle control model (M) is adapted to form a compensation control value (CCV) for operating the vehicle (100),
operate the vehicle (100) based on a combination of the reference control value (V1) and the compensation control value (CCV),
receive vehicle data (VD) resulting from the operation of the vehicle (100),
determine a difference (A) between the reference control value (V1) and the vehicle data (VD), and
update the vehicle control model (M) if the determined difference (A) is above a predetermined threshold (T).

2. The system according to claim 1, wherein the processing circuitry implements a control function and the control function receives the difference between the reference control value and the vehicle data.

3. The system according to claim 2, wherein the control function is implemented as a PID controller.

4. The system according to any one of claims 2 and 3, wherein an output from the control function is combined with the compensation control value for forming a control signal, and the control signal is applied to operate the vehicle.

5. The system according to any one of the preceding claims, wherein the reference control value is a desired acceleration value and or a desired speed value for the vehicle.

6. The system according to any one of the preceding claims, wherein the vehicle state values are selected from a group comprising one or a plurality of a road inclination, a vehicle mass, a speed of the vehicle, power limits for the vehicle, gear box ratio.

7. The system according to any one of the preceding claims, wherein the vehicle data is a measured output resulting from the operation of the vehicle.

8. The system according to any one of the preceding claims, wherein the predetermined threshold is dependent on the reference control value.

9. The system according to claim 1, wherein the updated vehicle control model is transmitted to a remote server arranged off-board the vehicle arranged in networked communication with the processing circuitry.

10. The system according to claim 1, wherein an initial vehicle control model is received from a remote server off-board the vehicle arranged in networked communication with the processing circuitry.

11. A vehicle, comprising an on-board control system according to any one of claims 1-10.

12. The vehicle according to claim 11, wherein the vehicle is a truck (100), a bus (102) or a working machine (104).

13. The vehicle according to any one of claims 10 and 11, wherein the vehicle is autonomously operated.

14. A computer implemented method for operating a control system arranged on-board a vehicle, the control system comprising processing circuitry and a plurality of sensors arranged with the vehicle, the processing circuitry arranged in communication with the plurality of sensors, wherein the method comprises the steps of:
receiving (S1), at the processing circuitry, a reference control value for operating the vehicle,
receiving (S2), at the processing circuitry, vehicle state values from the plurality of sensors,
providing (S3), by the processing circuitry, the reference control value and the vehicle state values as inputs to a vehicle control model, wherein the vehicle control model is adapted to form a compensation control value for operating the vehicle,
operating (S4), by the processing circuitry, the vehicle based on a combination of the reference control value and the compensation control value,
receiving (S5), at the processing circuitry, vehicle data resulting from the operation of the vehicle,
determining (S6), at the processing circuitry, a difference between the reference control value and the vehicle data, and
updating (S7), at the processing circuitry, the vehicle control model if the determined difference is above a predetermined threshold.

15. The method according to claim 14, wherein the processing circuitry implements a control function and the control function receives the difference between the reference control value and the vehicle data.

16. The method according to claim 15, wherein the control function is implemented as a PID controller.

17. The method according to any one of claims 15 and 16, wherein an output from the control function is combined with the compensation control value for forming a control signal, and the control signal is applied to operate the vehicle.

18. The method according to any one of claims 14-17, wherein the reference control value is a desired acceleration value and or a desired speed value for the vehicle.

19. The method according to any one of claims 14-18, wherein the vehicle state values are selected from a group comprising one or a plurality of a road inclination, a vehicle mass, a speed of the vehicle, power limits for the vehicle, gear box ratio.

20. The method according to any one of claims 14-19, wherein the vehicle data is a measured output resulting from the operation of the vehicle.

21. The method according to any one claims 14-20, wherein the predetermined threshold is dependent on the reference control value.

22. The method according to claim 14, wherein the updated vehicle control model is transmitted to a remote server arranged off-board the vehicle arranged in networked communication with the processing circuitry.

23. The method according to claim 14, wherein an initial vehicle control model is received from a remote server off-board the vehicle arranged in networked communication with the processing circuitry.

24. A computer program product comprising a non-transitory computer readable medium having stored thereon computer program means for operating a control system arranged on-board a vehicle, the control system comprising processing circuitry and a plurality of sensors arranged with the vehicle, the processing circuitry arranged in communication with the plurality of sensors, wherein the computer program product comprises:
code for receiving, at the processing circuitry, a reference control value for operating the vehicle,
code for receiving, at the processing circuitry, vehicle state values from the plurality of sensors,
code for providing, by the processing circuitry, the reference control value and the vehicle state values as inputs to a vehicle control model, wherein the vehicle control model is adapted to form a compensation control value for operating the vehicle,
code for operating, by the processing circuitry, the vehicle based on a combination of the reference control value and the compensation control value,
code for receiving, at the processing circuitry, vehicle data resulting from the operation of the vehicle,
code for determining, at the processing circuitry, a difference between the reference control value and the vehicle data, and
code for updating, at the processing circuitry, the vehicle control model if the determined difference is above a predetermined threshold.
